(19) United States
(12) Patent Application Publication
(10) Pub. No.: US 2018/0237251 A1
(43) Pub. Date: Aug. 23, 2018

(54) SHEET PROCESSING APPARATUS AND SHEET PROCESSING METHOD

(71) Applicants: KABUSHIKI KAISHA TOSHIBA, Tokyo (JP); TOSHIBA TEC KABUSHIKI KAISHA, Tokyo (JP)

(72) Inventor: Hiroyuki Taki, Mishima Shizuoka (JP)

(21) Appl. No.: 15/438,983

(22) Filed: Feb. 22, 2017

(51) Int. Cl. B65H 29/20; G03G 15/00; B65H 43/00

(52) U.S. Cl. CPC B65H 29/20; B65H 2801/27; B65H 43/00; G03G 15/6538

(57) ABSTRACT

A sheet processing apparatus comprises a first tray; a second tray arranged at a downstream side of a sheet conveyance direction with respect to the first tray; a rotating body which conveys a sheet on the first tray; a receiving section arranged at an upstream side of the sheet conveyance direction with respect to the first tray to receive the sheet conveyed by the rotating body; a conveyance section which extrudes one side of the sheet placed on the first tray at the upstream side of the sheet conveyance direction with a convex part to convey the sheet to the second tray; and a controller which extrudes the sheet placed on the receiving section with the convex part in a case in which a final sheet of a sheet bundle is placed on the first tray and the sheet is placed on the receiving section, and controls the conveyance section to convey the sheet by extruding one side of the final sheet at the upstream side of the sheet conveyance direction with the convex part while the sheet is conveyed to the second tray.

### FIELD

Embodiments described herein relate generally to a sheet processing apparatus and a sheet processing method.

### BACKGROUND

There is known a sheet processing apparatus for executing a prescribed post-processing to a sheet (e.g., paper) conveyed from an image forming apparatus. The sheet processing apparatus comprises a processing section for executing a post-processing and a standby section arranged above the processing section. The standby section temporarily retains the subsequent sheet while post-processing to the sheet is executed in the processing section. The standby section drops the sheet that is retained towards the processing section if the processing section is empty.

In a case in which a vertical alignment for determining a position in a conveyance direction of the sheet dropped to a processing tray is executed, a sheet feed member abuts against a surface of the sheet dropped to the processing tray by backward feeding the sheet to an upstream side of the conveyance direction. A vertical alignment member is arranged at the upstream side of the processing tray to abut against an edge of the sheet at the upstream side of the conveyance direction that is backward fed to the vertical alignment member. Thus, the vertical alignment of the sheet that is backward fed is executed. In a case in which the vertical alignment of an additional sheet is further executed in addition to the sheet that is retained, every time the additional sheet is dropped to the processing tray, the vertical alignment is executed by backward feeding the additional sheet (sheet at the uppermost position).

After the vertical alignment mentioned above, an extruding member retracting from the processing tray is operated to extrude the edge at the upstream side of the conveyance direction of the sheet abutting against the vertical alignment member towards a downstream side of the conveyance direction. Thus, the sheet to which the vertical alignment is executed is moved towards the downstream side of the conveyance direction to be discharged from the processing tray.

However, in a case in which a sheet bundle composed of a plurality of the sheets is formed, as the vertical alignment is executed by backward feeding the sheet at the uppermost position every time a plurality of the sheets is dropped to the processing tray, the processing time required for the vertical alignment of the sheet bundle is likely to undesirably increase.

### DESCRIPTION OF THE DRAWINGS

FIG. 1 is a front view illustrating the constitution of an image forming system according to an embodiment;

FIG. 2 is a block diagram illustrating the constitution of the image forming system according to the embodiment;

FIG. 3 is a sectional view illustrating the constitution of a post-processing apparatus in the image forming system according to the embodiment;

FIG. 4 is a perspective view illustrating a standby section and a processing section of the post-processing apparatus according to the embodiment;

FIG. 5 is a sectional view illustrating the standby section and the processing section according to the embodiment;

FIG. 6 is a sectional view illustrating the standby section and the processing section according to the embodiment and also illustrating an operation example of an assist guide;

FIG. 7 is a diagram illustrating operations of the post-processing apparatus according to the embodiment in the order of (a)˜(c);

FIG. 8 is a diagram illustrating operations of the post-processing apparatus according to the embodiment in the order of (d)˜(f);

FIG. 9 is a diagram illustrating operations of the post-processing apparatus according to the embodiment in the order of (g)˜(i); and

FIG. 10 is a time chart exemplifying the operation of each section of the post-processing apparatus according to the embodiment.

### DETAILED DESCRIPTION

In accordance with an embodiment, a sheet processing apparatus comprises a first tray, a second tray, a rotating body, a receiving section, a conveyance section and a controller. The second tray is arranged at a downstream side of a sheet conveyance direction with respect to the first tray. The rotating body conveys a sheet on the first tray. The receiving section is arranged at an upstream side of the sheet conveyance direction with respect to the first tray to receive the sheet conveyed by the rotating body. The conveyance section extrudes one side at the upstream side of the sheet conveyance direction of the sheet placed on the first tray with a convex part to convey the sheet to the second tray. The controller extrudes the sheet placed on the receiving section with the convex part in a case in which a final sheet of a sheet bundle is placed on the first tray and the sheet is placed on the receiving section. The controller controls the conveyance section to convey the sheet by extruding one side of the final sheet at the upstream side of the sheet conveyance direction with the convex part while the sheet is conveyed to the second tray.

In accordance with an embodiment, a sheet processing method involves a sheet feeding process and a final sheet feeding process. The sheet feeding process involves extruding one side at an upstream side of a sheet conveyance direction of a sheet placed on a first tray with a convex part to convey the sheet to a second tray. The final sheet feeding process involves extruding the sheet placed on a receiving section arranged at the upstream side of the sheet conveyance direction with respect to the first tray with the convex part in a case in which a final sheet of a sheet bundle is placed on the first tray and the sheet is placed on the receiving section. The final sheet feeding process involves controlling the conveyance section to convey the sheet by extruding one side of the final sheet at the upstream side of the sheet conveyance direction with the convex part while the sheet is conveyed to the second tray.

Hereinafter, the sheet processing apparatus of an embodiment is described with reference to the accompanying drawings. In the following description, the components with the same or similar functions are donated with the same reference numerals. The overlapping description of those components is omitted in some cases.

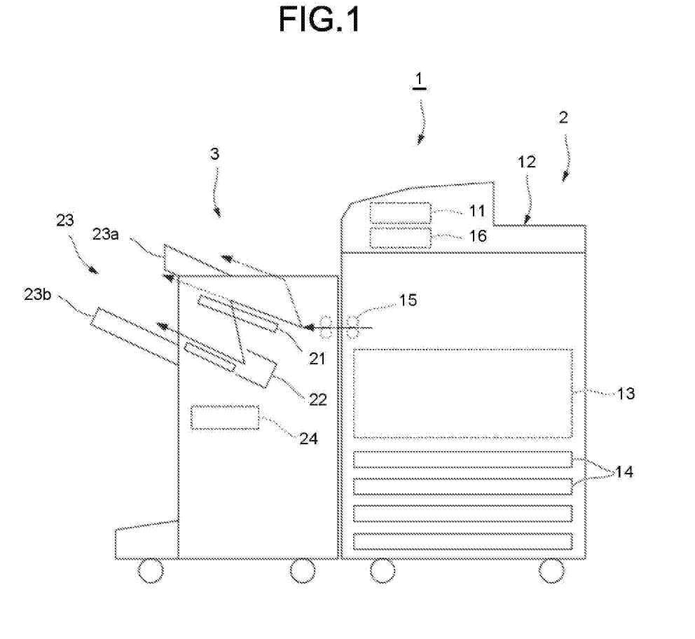

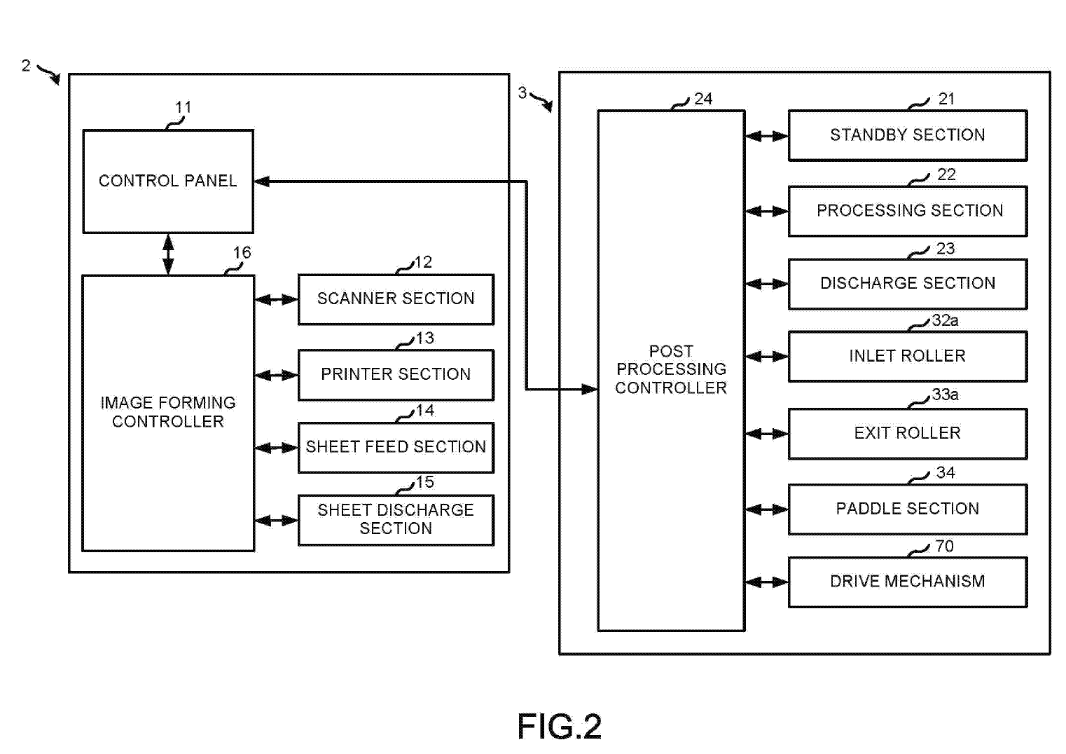

With reference to FIG. 1 to FIG. 10, a sheet processing apparatus of one embodiment is described. First, FIG. 1 and FIG. 2 exemplify the whole constitution of an image forming system 1. The image forming system 1 contains an image forming apparatus 2 and a post-processing apparatus 3. The image forming apparatus forms an image on a sheet-like image receiving medium (hereinafter, referred to as a “sheet S”) such a paper. The post-processing apparatus 3 executes a post-processing to the sheet S conveyed from the image forming apparatus 2. The post-processing apparatus 3 is an example of the “sheet processing apparatus”.

The image forming apparatus 2 includes a control panel 11, a scanner section 12, a printer section 13, a sheet feed section 14, a sheet discharge section 15 and an image forming controller 16.

The control panel 11 includes various keys or a touch panel to receive an operation by a user. For example, the control panel 11 receives an input relating to the type of a post-processing of the sheet S. The image forming apparatus 2 sends information relating to the type of the post-processing input by the control panel 11 to the post-processing apparatus 3.

The scanner section 12 includes a reading section that reads image information of a copied object. The scanner section 12 sends the read image information to the printer section 13.

The printer section 13 forms an output image (hereinafter referred to as a “toner image”) with a developing agent such as a toner based on image information transmitted from the scanner section 12 or an external device. The printer section 13 transfers the toner image onto the surface of the sheet S. The printer section 13 applies heat and pressure to the toner image transferred to the sheet S to fix the toner image on the sheet S.

The sheet feed section 14 supplies the sheet S one by one to the printer section 13 in accordance with a timing at which the printer section 13 forms the toner image.

The sheet discharge section 15 conveys the sheet S discharged from the printer section 13 to the post-processing apparatus 3.

The image forming controller 16 controls the overall operation of the image forming apparatus 2. In other words, the image forming controller 16 controls the control panel 11, the scanner section 12, the printer section 13, the paper feed section 14 and the paper discharge section 15. The image forming controller 16 is formed of a control circuit including a CPU (Central Processing Unit), a ROM (Read Only Memory) and a RAM (Random Access Memory).

Next, the post-processing apparatus 3 is described.

The whole constitution of the post-processing apparatus 3 is described. As shown in FIG. 1, the post-processing apparatus 3 is arranged to be adjacent to the image forming apparatus 2. The post-processing apparatus 3 executes the post-processing designated via the control panel 11 to the sheet S conveyed from the image forming apparatus 2. For example, the post-processing is a sheet binding processing or a sorting processing.

The post-processing apparatus 3 includes a standby section 21, a processing section 22, a discharge section 23 and a post-processing controller (controller) 24.

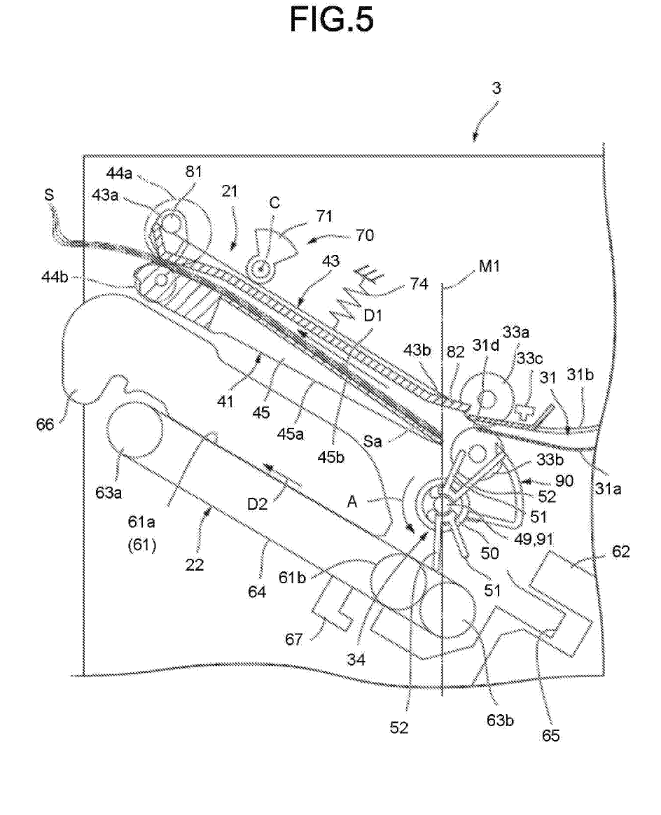

As shown in FIG. 5, the standby section 21 temporarily retains (buffers) the sheet S conveyed from the image forming apparatus 2. The standby section 21 includes a standby tray 41. For example, the standby section 21 enables the plurality of subsequent sheets S to stand by while the post-processing of the preceding sheet S is executed in the processing section 22. The standby section 21 is arranged above the processing section 22. For example, the standby section 21 enables a plurality of the sheets S to stand by in an overlapped manner. The standby section 21 drops the retained sheet S towards the processing section 22 if the processing section 22 is empty.

The processing section 22 executes the post-processing to the conveyed sheet S. The processing section 22 includes a processing tray (first tray) 61. For example, the processing section 22 executes the sorting processing for unifying a plurality of the sheets S to align them. For example, the processing section 22 executes the sheet binding processing with a stapler or an adhesive tape to a sheet bundle obtained by unifying the plurality of the sheets S. The processing section 22 discharges the sheet S to which the post-processing is executed to the discharge section 23.

As shown in FIG. 1, the discharge section 23 includes a fixed tray 23a and a movable tray (second tray) 23b. The fixed tray 23a is arranged at the upper part of the post-processing apparatus 3. The movable tray 23b is arranged at a lateral part of the post-processing apparatus 3. The sheet S from the standby section 21 and the processing section 22 is discharged to the fixed tray 23a and the movable tray 23b.

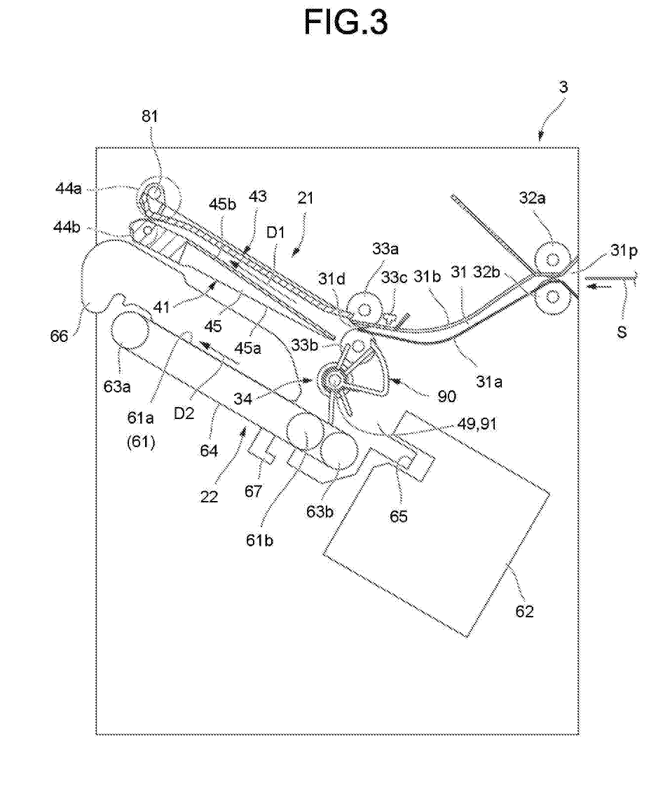

The post-processing controller 24 controls the overall operation of the post-processing apparatus 3. In other words, the post-processing controller 24 controls the standby section 21, the processing section 22 and the discharge section 23. As shown in FIG. 3 and FIG. 5, the post-processing controller 24 controls entrance rollers 32a and 32b described later, exit rollers 33a and 33b, a rotating body 34, an assist guide (sheet drop member) 43 and a rear end zipper 90. The post-processing controller 24 is formed of a control circuit containing a CPU, a ROM and a RAM, which is similar to the image forming controller 16.

The components of each section in the post-processing apparatus 3 are described in detail.

Further, the “sheet conveyance direction” in the present invention is indicated by an arrow D1 in the standby section 21, and is also indicated by an arrow D2 in the processing section 22. The arrow D1 refers to a conveyance direction (entry direction of the sheet S to the standby tray 41) of the sheet S on the standby tray 41. The arrow D2 refers to a conveyance direction (discharge direction of the sheet S from the processing tray 61) of the sheet S on the processing tray 61.

An “upstream side” and a “downstream side” in the present invention respectively refer to an upstream side (the image forming apparatus 2 side) and a downstream side in the sheet conveyance direction. A “front end” and a “rear end” in the present application respectively refer to a “downstream side end” and an “upstream side end” in the sheet conveyance direction. Further, in the present application, a direction substantially parallel to a plane of the sheet S and substantially orthogonal to the sheet conveyance direction is referred to as a sheet width direction W.

FIG. 3 is a diagram schematically illustrating the constitution of the post-processing apparatus 3. As shown in FIG. 3, the post-processing apparatus 3 includes a conveyance path (sheet conveyance path) 31 of the sheet S, a pair of entrance rollers 32a and 32b, a pair of exit rollers 33a and 33b, the standby section 21, the rotating body 34 and the processing section 22.

The conveyance path 31 is arranged at the inner side of the post-processing apparatus 3. For example, the conveyance path 31 is formed by a first guide member 31a and a second guide member 31b. The first guide member 31a forms a lower surface of the conveyance path 31. The second guide member 31b is positioned at an opposite side (upper surface side) to the first guide member 31a with respect to the conveyance path 31. The second guide member 31b forms the upper surface of the conveyance path 31. The conveyance path 31 includes a sheet supply port 31p and a sheet discharge port 31d. The sheet supply port 31p faces the image forming apparatus 2. The sheet S from the image forming apparatus 2 is supplied to the sheet supply port 31p. The sheet discharge port 31d is positioned nearby the standby section 21. The sheet S passing through the conveyance path 31 is discharged from the sheet discharge port 31d to the standby section 21.

The entrance rollers 32a and 32b are arranged nearby the sheet supply port 31p. The entrance rollers 32a and 32b are parallel to each other to face each other in a radial direction. The entrance roller 32a is a driving roller arranged at the upper surface side of the conveyance path 31. The entrance roller 32b is a driven roller arranged at the lower surface side of the conveyance path 31. The entrance rollers 32a and 32b sandwich the sheet S therebetween. The entrance rollers 32a and 32b convey the sheet S supplied to the sheet supply port 31p towards the downstream side of the conveyance path 31. The entrance rollers 32a and 32b convey the sheet S to the exit rollers 33a and 33b.

The exit rollers 33a and 33b are arranged nearby the sheet discharge port 31d. The exit rollers 33a and 33b are parallel to each other to face each other in a radial direction. The exit roller 33a is a driving roller arranged at the upper surface side of the conveyance path 31. The exit roller 33b is a driven roller arranged at the lower surface side of the conveyance path 31. The exit rollers 33a and 33b sandwich the sheet S therebetween. The exit rollers 33a and 33b conveys the sheet S conveyed by the entrance rollers 32a and 32b from the sheet discharge port 31d towards the standby section 21. The exit roller 33a is connected to an exit roller motor described later.

The standby section 21 is described.

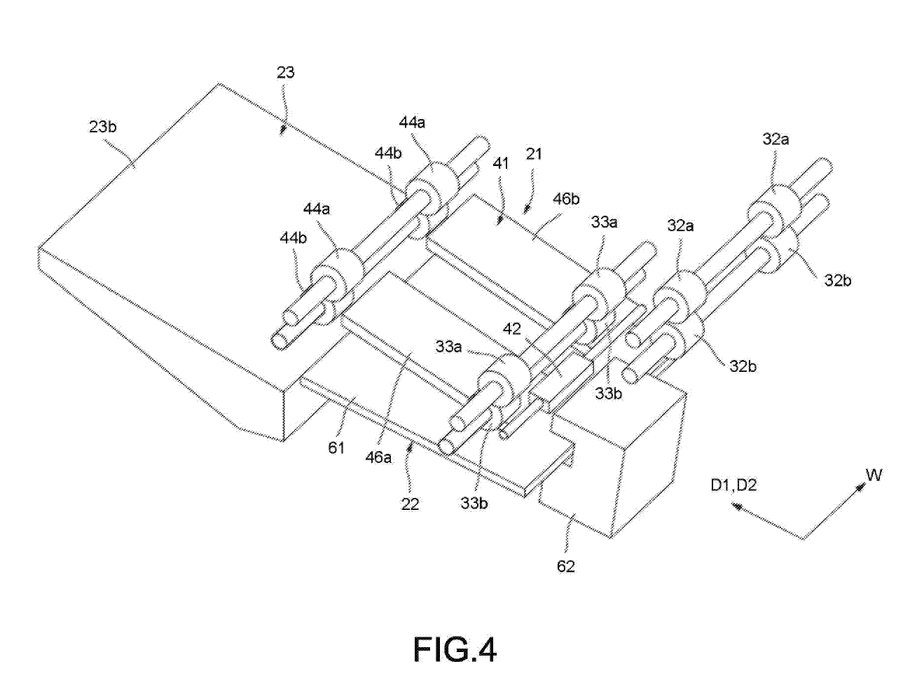

The standby section 21 includes the standby tray (buffer tray) 41, an opening and closing drive section 42 (refer to FIG. 4), an assist guide 43 and discharge rollers 44a and 44b.

The rear end of the standby tray 41 is arranged nearby the exit rollers 33a and 33b. The rear end of the standby tray 41 is arranged below the sheet discharge port 31d of the conveyance path 31. The standby tray 41 is inclined with respect to a horizontal direction in such a manner that the standby tray 41 gradually increases as proceeding to the downstream side of the sheet conveyance direction D1. The standby tray 41 enables a necessary number of sheets S to stand by while the post-processing is executed in the processing section 22.

The standby tray 41 includes a bottom wall 45 and side walls (not shown). The bottom wall 45 has a lower surface 45a and an upper surface (conveyance surface) 45b. The bottom wall 45 supports the sheet S from below. The side walls support the sides of the sheet S in the sheet width direction W.

FIG. 4 is a diagram schematically illustrating the standby tray 41. As shown in FIG. 4, the standby tray 41 includes a first plate part 46a and a second plate part 46b. The first plate part 46a and the second plate part 46b are separated from each other in the sheet width direction W. The first plate part 46a and the second plate part 46b can be moved in a direction close to each other or a direction away from each other.

The opening and closing drive section 42 can move the first plate part 46a and the second plate part 46b in a direction close to each other or a direction away from each other. The opening and closing drive section 42 moves the first plate part 46a and the second plate part 46b close to each other if the sheet S stands by on the standby tray 41. Thus, the sheet S is supported by the first plate part 46a and the second plate part 46b. On the other hand, the opening and closing drive section 42 moves the first plate part 46a and the second plate part 46b separate from each other in a case in which the sheet S is moved towards the processing tray 61 of the processing section 22 from the standby tray 41. Thus, the sheet S supported by the standby tray 41 is dropped to the processing tray 61 from an opening between the first plate part 46a and the second plate part 46b. Thus, the sheet S is moved from the standby tray 41 to the processing tray 61.

FIG. 5 is an enlarged view of the assist guide 43. As shown in FIG. 5, the assist guide 43 is arranged above the standby tray 41. For example, the assist guide 43 is substantially as long as the standby tray 41 in the sheet conveyance direction D1. The assist guide 43 is a plate-like member which extends above the standby tray 41. The sheet S discharged from the exit rollers 33a and 33b enters a gap between the assist guide 43 and the standby tray 41. The sheet S entering the standby section 21 is guided by the assist guide 43 and the standby tray 41 to proceed towards the downstream side of the standby section 21.

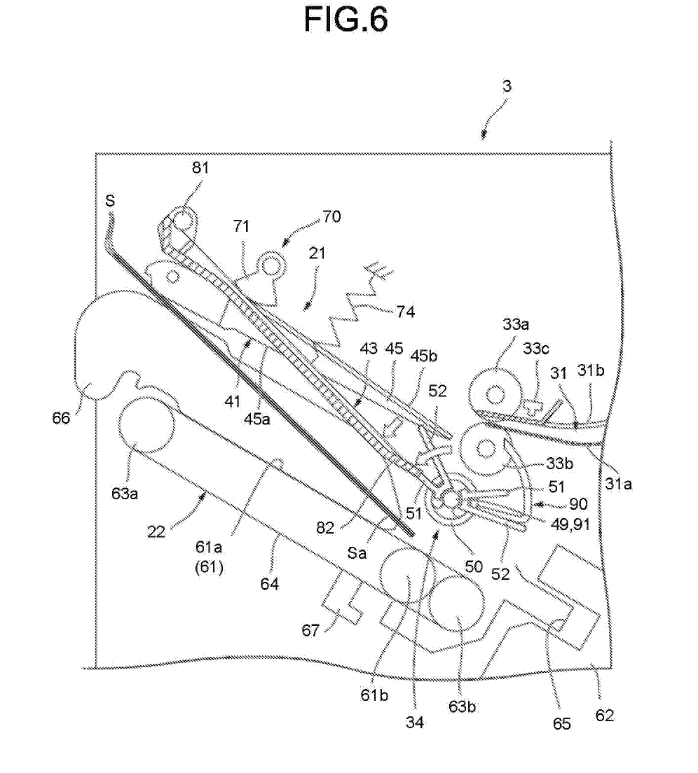

The assist guide 43 energizes the sheet S towards the processing tray 61 in a case in which the sheet S is moved from the standby tray 41 towards the processing tray 61. Specifically, the assist guide 43 can be moved between a standby position (refer to FIG. 5) and a projecting position (refer to FIG. 6) moving below the standby position. At the standby position, the whole assist guide 43 is positioned above the standby tray 41. At the standby position, the assist guide 43 is positioned above the sheet discharge port 31d of the conveyance path 31. At the projecting position, at least a part of the assist guide 43 projects downwards with respect to the lower surface 45a of the standby tray 41. The assist guide 43 moves from the standby position to the projecting position in a case in which the sheet S is moved from the standby tray 41 to the processing tray 61.

As shown in FIG. 5, the assist guide 43 includes a first end 43a and a second end 43b in the sheet conveyance direction D1. The first end 43a is an end at the downstream side of the sheet conveyance direction D1. The second end 43b is an end at the upstream side of the sheet conveyance direction D1.

The first end 43a has a rotation axis 81 which is a rotation fulcrum (rotation center) of the assist guide 43. The rotation axis 81 is arranged at a position substantially the same as the front end of the standby tray 41 in the sheet conveyance direction D1. For example, the rotation axis 81 is positioned nearby a discharge roller 44a positioned above the standby tray 41.

The second end 43b forms an extrusion part 82 contacting with the sheet S. The extrusion part 82 is close to or separate from the processing tray 61 by rotating the assist guide 43 around the rotation axis 81. The extrusion part 82 extrudes the upstream side of the sheet S towards the processing tray 61 in a case in which the sheet S is moved from the standby tray 41 towards the processing tray 61.

The extrusion part 82 is arranged nearby the sheet discharge port 31d of the conveyance path 31. For example, the extrusion part 82 is overlapped with a vertical line M1 passing through an axis center of a rotation axis 49 of the rotating body 34 described later in a side view in FIG. 5. The extrusion part 82 extends to the vicinity of the sheet discharge port 31d with respect to the vertical line M1.

FIG. 6 is a diagram illustrating the assist guide 43 moving to the projecting position. As shown in FIG. 6, the extrusion part 82 extrudes a rear end Sa of the sheet S towards the processing tray 61 (downward).

A drive mechanism 70 for driving the assist guide 43 is described.

As shown in FIG. 5, the drive mechanism 70 has a drive member 71 and a spring 74.

The drive member 71 moves the assist guide 43 from the standby position to the projecting position. For example, the drive member 71 is a cam. The drive member 71 has a rotation center C arranged above the standby tray 41. The drive member 71 has an outer peripheral surface that is eccentric with respect to the rotation center C. The drive member 71 rotates around the rotation center C to contact with the upper surface of the assist guide 43. The drive member 71 extrudes the assist guide 43 downwards by further rotating in a state in which the drive member 71 contacts with the upper surface of the assist guide 43. The assist guide 43 moves from the standby position to the projecting position by extruding the drive member 71 downward. The drive member 71 is connected with a drop motor described later.

As shown in FIG. 5, the spring 74 is arranged above the assist guide 43. The spring 74 energizes the assist guide 43 upwards. The assist guide 43 returns to the standby position by an energizing force of the spring 74 if the extrusion by the drive member 71 is released.

The discharge rollers 44a and 44b are arranged nearby the front end of the standby tray 41. The discharge rollers 44a and 44b are parallel to each other to face each other in a radial direction. The discharge roller 44a is a driving roller arranged at the upper surface 45b side of the standby tray 41. The discharge roller 44b is a driven roller arranged at the lower surface 45a side of the standby tray 41. The discharge rollers 44a and 44b sandwich the sheet S therebetween. The discharge roller 44a drives forward to convey to the sheet S of the fixed tray 23a of the discharge section 23 in a case in which the sheet S is directly discharged from the standby tray 41 to the discharge section 23.

The rotating body 34 is described.

As shown in FIG. 5, the rotating body 34 is arranged between the upstream side of the standby tray 41 and the upstream side of the processing tray 61. The rotating body 34 extrudes the sheet S towards the processing tray 61 (refer to FIG. 6) by rotating around the rotation axis 49. The rotating body 34 extrudes the sheet S towards the processing tray 61 in a case in which the sheet S is moved from the standby tray 41 towards the processing tray 61. The rotating body 34 moves the sheet S dropped to the processing tray 61 towards the upstream side in the sheet conveyance direction D2 of the processing section 22.

The rotating body 34 has a rotation axis 49, a rotation center body 50, a plurality of first paddles 51 and a plurality of second paddles 52.

The rotation axis 49 is a rotation center of the rotating body 34. The rotation axis 49 is positioned below the standby tray 41. The rotation axis 49 extends towards the sheet width direction W. The rotating body 34 rotates around the rotation axis 49 in an arrow A direction in FIG. 5.

The rotation center body 50 is formed into a cylindrical shape. The rotation center body 50 is rotated around the rotation axis 49. The first paddle 51 and the second paddle 52 are mounted on the rotation center body 50.

The first paddle 51 and the second paddle 52 protrude from the rotation center body 50 in a radial direction of the rotation center body 50. The first paddle 51 and the second paddle 52 are formed by an elastic material such as rubber. For example, the first paddle 51 is rotated in accordance with a timing at which the sheet S is moved from the standby tray 41 towards the processing tray 61. The first paddle 51 extrudes the sheet S towards the processing tray 61 by rotating around the rotation axis 49. The first paddle 51 peels the sheet S from the assist guide 43 to move the sheet S towards the processing tray 61 even in a case in which the sheet S sticks to the assist guide 43 by static electricity or the like.

The second paddle 52 is arranged at an opposite side to the arrow A direction with respect to the first paddle 51 in the rotation direction of the rotating body 34. In the radial direction of the rotation center body 50, the length of the second paddle 52 is longer than that of the first paddle 51. The second paddle 52 contacts with the upper surface of the sheet S at the uppermost position in a plurality of the sheets S dropped to the processing tray 61 by being rotated around the rotation axis 49. The second paddle 52 moves the sheet S to the upstream side in the sheet conveyance direction D2 by being further rotated in a state of contacting with the upper surface of the sheet S. The rotating body 34 combines a sheet feed member for feeding the sheet S at the uppermost position on the processing tray 61 backward to the upstream side of the sheet conveyance direction D2 and a moving restriction member for restricting the movement of the final sheet S2 of a sheet bundle SS towards the downstream side of the sheet conveyance direction D2. In the rotating body 34, a rotation position before the sheet S is extruded towards the processing tray 61 is set to an initial position.

The standby section 21 has a component for extruding the rear end Sa of the sheet S in such a manner that the sheet S does not rise on the standby tray 41. The standby section 21 has a rear end zipper 90 as one member for extruding the rear end Sa of the sheet S on the standby tray 41. For example, a rotation axis 91 of the rear end zipper 90 is arranged coaxially with the rotation axis 49 of the rotating body 34.

The rear end zipper 90 extrudes the rear end Sa of the sheet S placed formerly at the time a sheet conveyance device containing the exit roller 33a and the discharge roller 44a conveys the second sheet S and subsequent sheets S to the standby section 21. The rear end zipper 90 permits the entry of the next sheet S to the standby section 21 at both a holding position for holding the upstream side end of the sheet S and a releasing position for releasing the holding of the upstream side end of the sheet S.

An exit sensor 33c for detecting the downstream side end of the sheet S is arranged nearby the exit roller 33a. For example, according to a detection signal by the exit sensor 33c, the post-processing controller 24 carries out a pulse control to drive motors (not shown) of the exit roller 33a, the assist guide 43 and the rotating body 34.

The processing section 22 is described.

The processing section 22 includes the processing tray 61, a sheet binding processing section 62, conveyance rollers 63a and 63b, and a conveyance belt 64. One of the conveyance rollers 63a and 63b is a driving roller, and the conveyance belt 64 is driven by the rotation of the driving roller.

The processing tray 61 is arranged below the standby tray 41. The processing tray 61 is inclined with respect to the horizontal direction in such a manner that the processing tray 61 gradually rises as proceeding to the downstream side of the sheet conveyance direction D2. For example, the processing tray 61 is substantially parallel to the standby tray 41. For example, the sheet S moving to the processing tray 61 is aligned in the sheet conveyance direction D2 by a rear end stopper (the receiving section, a vertical alignment member) 65 arranged at the back of the upstream side of the processing section 22. The sheet S moving to the processing tray 61 is aligned in the sheet width direction W by horizontal alignment plates (horizontal alignment members) 66 arranged at both sides of the processing section 22 in the sheet width direction W.

For example, the processing section 22 has a friction roller 61b exposed towards a sheet placing surface 61a of the processing tray 61. The friction roller 61b drives at the time of moving the sheet S dropped to the processing tray 61 to a conveyance direction upstream side.

The processing section 22 includes a bundle claw (convex part, the extrusion member) 67 which is arranged on the conveyance belt 64 to be driven integrally with the conveyance belt 64. The bundle claw 67 is driven together with the conveyance belt 64 to move the sheet S on the processing tray 61 to a conveyance direction downstream side.

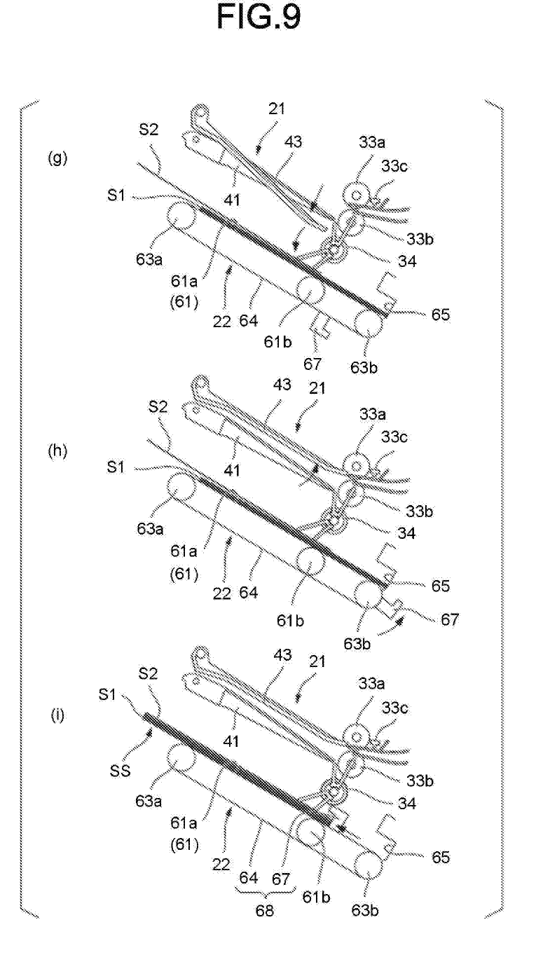

For example, the post-processing apparatus 3 overlaps three sheets S at the most on the standby tray 41 to enable the sheets stand by in a case in which the sorting processing to a plurality of the sheets S is executed at the processing tray 61. The post-processing apparatus 3 places the sheets S one by one on the processing tray 61 after a plurality of the sheets S is moved from the standby tray 41 to the processing tray 61. The standby tray 41 opens the first plate part 46a and the second plate part 46b at the time the sheet S is moved to the processing tray 61. The post-processing apparatus 3 directly conveys the sheets S one by one from the exit rollers 33a and 33b to the processing tray 61 in a state in which the standby tray 41 is opened. Hereinafter, with reference to FIG. 9, a sheet S that is placed on the processing tray 61 formerly and is overlaid with subsequent sheets S is set to a first sheet S1, and the sheet S overlaid at the uppermost position as the final sheet of the sheet bundle SS formed in the sorting processing is set as a second sheet S2 (or a final sheet S2).

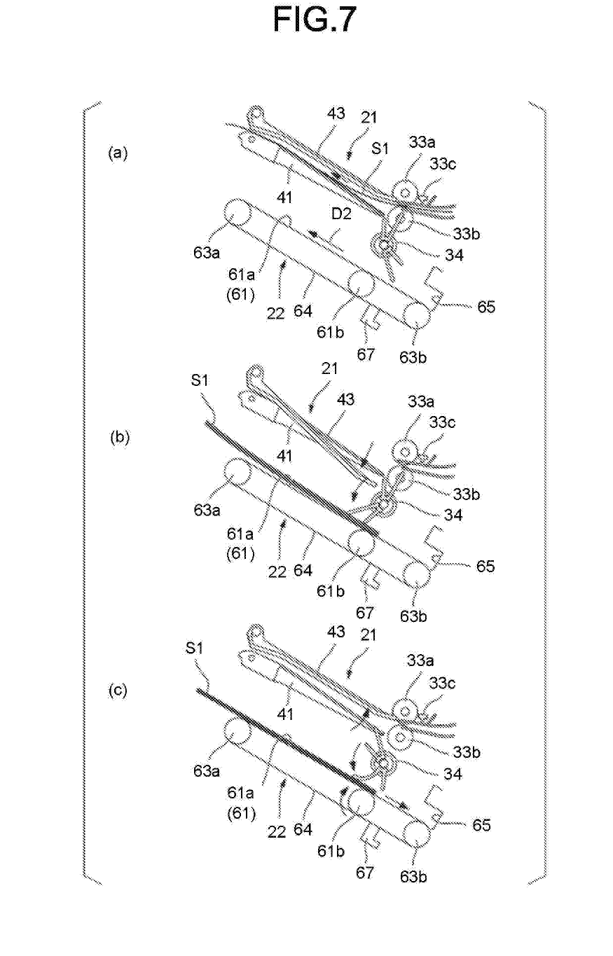

Under the control of the post-processing controller 24, procedures for aligning a plurality of the sheets S in the sheet conveyance direction D2 are described with reference to FIG. 7˜FIG. 9.

As shown in FIG. 7(a), the standby section 21 places the sheet S conveyed by the rotation of the exit roller 33a on the standby tray 41. For example, the standby section 21 enables a plurality of the sheets S to stand by in an overlapped manner as a sheet group on the standby tray 41. The standby section 21 may also enable one sheet S to stand by.

As shown in FIG. 7(b), the standby section 21 opens the standby tray 41 in accordance with a timing at which the processing by the processing section 22 is terminated to drop the sheet S (or the sheet group, the description in the following is the same) standing by to the processing tray 61. At this time, the assist guide 43 rotates to energize the sheet S towards the processing tray 61. The rotating body 34 also rotates to energize the sheet S towards the processing tray 61. The above process is set to a standby sheet arrangement process. For example, the standby tray 41 keeps open until the final sheet S2 of the sheet bundle SS is conveyed. At the time of conveying the sheet S to the processing tray 61, the bundle claw 67 is retracted from the sheet placing surface 61a of the processing tray 61.

As shown in FIG. 7(c), after the sheet S is dropped to the processing tray 61, the assist guide 43 returns to the standby position. The rotating body 34 extrudes the upper surface of the sheet S dropped to the processing tray 61. The rotating body 34 contacts with the sheet S with a lager coefficient of friction than the sheet S. The rotating body 34 rotates counterclockwise in FIG. 7(c) to backward feed the sheet S to the conveyance direction upstream side in a state of contacting with the upper surface of the sheet S dropped to the processing tray 61. The friction roller 61b of the processing tray 61 contacts with the lower surface of the sheet S dropped to the processing tray 61 and rotates clockwise in FIG. 7(c) to backward feed the sheet S to the conveyance direction upstream side. With the cooperation of the rotating body 34 and the friction roller 61b, one or a plurality of the sheets S dropped to the processing tray 61 are integrally backward fed (standby sheet backward feeding process). Further, the “backward feeding” is equivalent to a back feed of the sheet S. In other words, the “backward feeding” is equivalent to the conveyance of the sheet S in an opposite direction to the sheet conveyance direction D2.

In a case in which a plurality of the sheets S is dropped to the processing tray 61, the sheets S at the uppermost position and the lowermost position respectively contacting with the rotating body 34 and the friction roller 61b are directly backward fed by the rotating body 34 and the friction roller 61b. In a case in which three or more sheets S are backward fed, the sheet at the middle position which contact with neither the rotating body 34 nor the friction roller 61b is backward fed by friction caused by the contact with the sheets S at the uppermost position and the lowermost position.

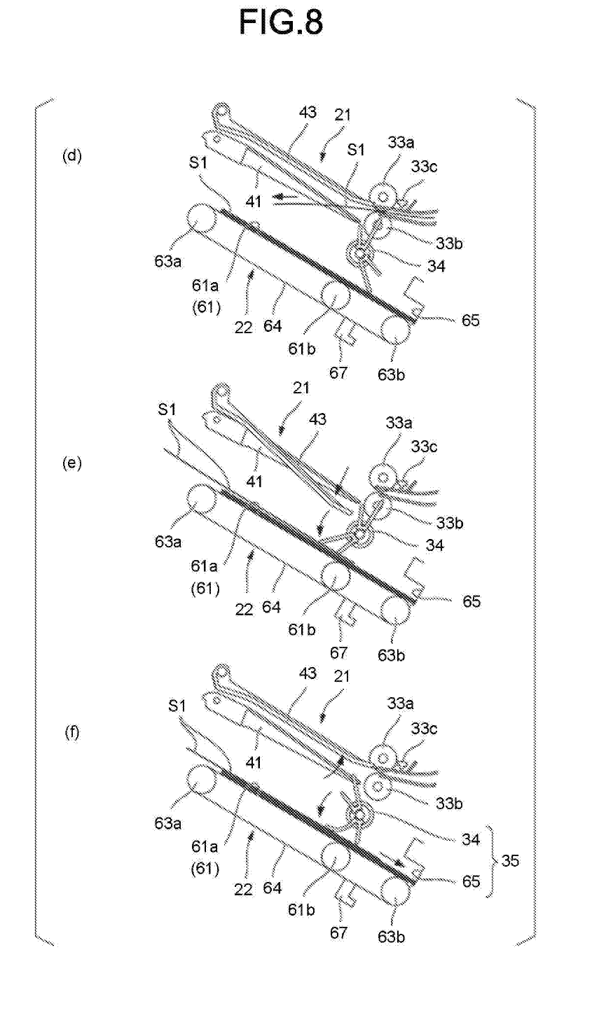

As shown in FIG. 8 (a), the edge at the conveyance direction upstream side of the sheet S that is backward fed collides against the rear end stopper 65 to become a vertical alignment state in which the conveyance direction positions thereof are aligned. A process, which contains the standby sheet arrangement process and the standby sheet backward feeding process, for executing the vertical alignment of the sheet S conveyed from the standby tray 41 is set to a standby sheet vertical alignment process. In the present embodiment, a vertical alignment device 35 is composed of the rotating body 34, the rear end stopper 65 and a paddle motor described later.

After backward feeding the sheet S, the rotating body 34 returns to the initial position after one rotation. For example, a subsequent sheet S passes through the opening of the standby tray 41 in an open state to be directly conveyed from the exit roller 33a to the processing tray 61. The subsequent sheet S is directly conveyed towards the processing tray 61 below the standby tray 41 without being placed on the standby tray 41. In another example, the subsequent sheet S is placed on the standby tray 41 and then is dropped to the processing tray 61 at a predetermined timing.

As shown in FIG. 8 (b), the subsequent sheet S is energized towards the processing tray 61 with the cooperation of the assist guide 43 and the rotating body 34. The subsequent sheet S is placed on the processing tray 61 by being overlaid on the preceding sheet S. The above process is referred to a subsequent sheet arrangement process.

As shown in FIG. 8(c), the rotating body 34 rotates counterclockwise in FIG. 8(c) in a state of contacting with the upper surface of the subsequent sheet S to backward feed subsequent sheets S (except for the final sheet S2) located at the uppermost position (or as the sheet group) one by one (subsequent sheet backward feeding process). The edge of the subsequent sheet S that is backward fed at the conveyance direction upstream side collides against the rear end stopper 65 to become the vertical alignment state in which the conveyance direction positions thereof are aligned together with the preceding sheet S. A process, which contains the subsequent sheet arrangement process and the subsequent sheet backward feeding process, for executing the vertical alignment of the subsequent sheet S is set to a subsequent sheet vertical alignment process. The processing section 22 executes the subsequent sheet vertical alignment process every time the subsequent sheet S is conveyed just before the final sheet S2 in the sheet bundle SS containing a prescribed number of sheets is conveyed.

The post-processing controller 24 detects that the final sheet S2 of the sheet bundle SS is conveyed by the detection signal of the exit sensor 33c. For example, the processing section 22 maintains a state of extruding the conveyed final sheet S2 towards the processing tray 61 with the rotating body 34 (refer to FIG. 9(a)). The movement of the final sheet S2 is stopped and the backward feeding is not executed.

As shown in FIG. 9(b) and FIG. 9(c), the processing section 22 drives the conveyance belt 64 to move the sheet bundle SS by the bundle claw 67 in a state in which the final sheet S2 is extruded by the rotating body 34. The bundle claw 67 abuts against the edge (one side) of the conveyance direction upstream side of the first sheet S1 (hereinafter, referred to as a vertically aligned first sheet S1) to which the vertical alignment is executed by the rear end stopper 65 for the vertically aligned first sheet S1. The bundle claw 67 extrudes the edge of the vertically aligned first sheet S1 at the conveyance direction upstream side towards the conveyance direction downstream side. The above process is set to a sheet movement process. In the present embodiment, a conveyance section 68 is composed of the conveyance belt 64, the bundle claw 67 and a bundle discharge motor described later. Even if the vertically aligned first sheet S1 moves to the conveyance direction downstream side, movement of the final sheet S2 by contacting with the rotating body 34 is restricted (remaining stopped in the example in FIG. 9).

The bundle claw 67 extrudes the sheet S to discharge the sheet S on the processing tray 61 to the discharge section 23. The bundle claw 67 abuts against the edge (one side) of the conveyance direction upstream side of the final sheet S2 while extruding the vertically aligned first sheet S1. The final sheet S2 abuts against the bundle claw 67 to form the sheet bundle SS to which the vertical alignment is executed together with the vertically aligned first sheet S1. In other words, the sheet movement process contains a vertical alignment process for vertically aligning the first sheet S1 and the second sheet S2. The bundle claw 67 overcomes the movement restriction by the rotating body 34 to move the sheet bundle SS to the conveyance direction downstream side.

Further, the second sheet S2 may be backward fed by the rotating body 34 similar to the first sheet S1 to collide against the bundle claw 67 before the second sheet S2 collides against the rear end stopper 65. However, in a constitution in which the second sheet S2 is stopped to abut against the bundle claw 67, the second sheet S2 and the bundle claw 67 have a low relative speed and the disorder of the second sheet S2 is suppressed. The processing section 22 may retract the rotating body 34 at the timing the bundle claw 67 abuts against the edge of the conveyance direction upstream side of the final sheet S2. The “vertically aligned first sheet S1” is not limited to a plurality of sheets and may be one.

For example, the processing section 22 starts the operation of the horizontal alignment plates 66 arranged at both sides of the sheet width direction W to simultaneously carry out the vertical alignment and the horizontal alignment of the sheet bundle SS before the bundle claw 67 abuts against the second sheet S2. The processing section 22 moves the sheet bundle SS to which the vertical alignment and the horizontal alignment are executed to the conveyance direction downstream side to discharge the sheet bundle SS to the movable tray 23b. Further, the horizontal alignment and the vertical alignment are not limited to being simultaneously carried out, and the vertical alignment may be executed after the horizontal alignment, or vice versa.

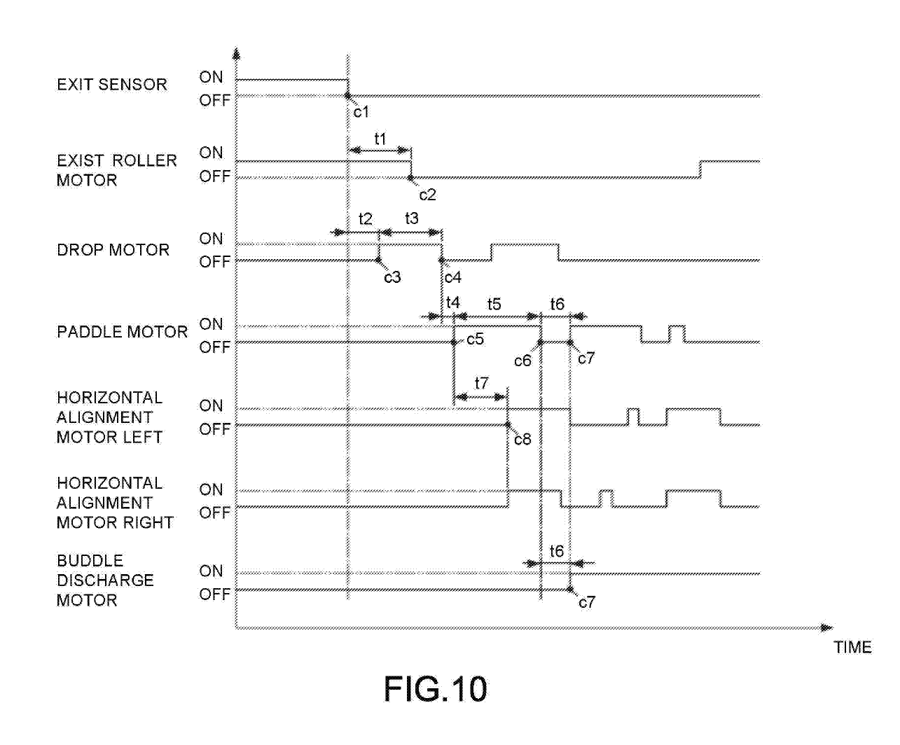

FIG. 10 is a time chart illustrating ON and OFF of an input and output signal between the post-processing controller 24 and various drive sources at the time of executing the post-processing to the final sheet S2.

As shown in FIG. 10, after the exit sensor 33c detects the downstream side end of the final sheet S2, the sheet detection signal from the exit sensor 33c is OFF. After a first prescribed time t1 elapses from a first timing c1 at which the detection signal of the exit sensor 33c becomes OFF, the drive signal to the exit roller motor becomes OFF, and the exit roller motor stops driving. After a second prescribed time t2 shorter than the first prescribed time t1 elapses from a second timing c2 at which the detection signal of the exit sensor 33c becomes OFF, the drive signal to the drop motor becomes ON, and the drop motor drives. The drop motor is a drive source of the assist guide 43, and by the driving of the drop motor, the assist guide 43 extrudes the final sheet S2 towards the processing tray 61. The drop motor temporarily stops after driving only for a third prescribed time t3 from a third timing c3 at which the drive signal becomes ON. After a fourth prescribed time t4 shorter than the second prescribed time t2 elapses from a fourth timing c4 at which the drop motor stops driving, the drive signal to the paddle motor becomes ON, and the paddle motor drives. The paddle motor is a drive source of the rotating body 34, and the rotating body 34 extrudes the final sheet S2 towards the processing tray 61 by the driving of the paddle motor.

In the example in FIG. 10, the paddle motor temporarily stops (timing c6) after driving only for a fifth prescribed time t5 from a fifth timing at which the drive signal becomes ON. If the paddle motor drives only for the fifth prescribed time t5, the rotating body 34 extrudes the final sheet S2 towards the processing tray 61. While the paddle motor drives only for the fifth prescribed time t5, the drop motor restarts driving, and the assist guide 43 assists the extrusion of the final sheet S2.

The paddle motor continues the rotation while including temporary stop, and the rotating body 34 returns to the initial state. The paddle motor stops driving only for a sixth prescribed time t6 after driving only for the fifth prescribed time t5. The paddle motor restarts driving at a timing c7 after the sixth prescribed time t6 elapses. At the timing c7, the drive signal to the bundle discharge motor becomes ON, and the bundle discharge motor starts driving. The bundle discharge motor is a drive source at the drive side of the conveyance rollers 63a and 63b, and the conveyance belt 64 is driven by the driving of the bundle discharge motor. By the driving of the conveyance belt 64, the bundle claw 67 moves towards the processing tray 61, and the vertically aligned first sheet S1 is moved towards the conveyance direction downstream side.

The driving of the paddle motor is restarted, and in this way, the final sheet S2 is backward fed towards the conveyance direction upstream side. At the time point of the backward feeding, the bundle claw 67 starts to extrude the vertically aligned first sheet S1. Thus, the final sheet S2 collides against the bundle claw 67 before the final sheet S2 is backward fed to the rear end stopper 65, and the vertical alignment is executed to the final sheet S2 together with the vertically aligned first sheet S1.

After a seventh prescribed time t7 shorter than the fifth prescribed time t5 elapses from the timing c5 at which the driving of the paddle motor is started, drive signals to right and left horizontal alignment motors become ON, and the right and left horizontal alignment motors drive. The left and right horizontal alignment motors are drive sources of the horizontal alignment plates 66 at both sides of the sheet width direction W, and by the driving of the left and right horizontal alignment motors, the horizontal alignment plates 66 at both sides of the sheet width direction W are respectively driven. By the driving of the horizontal alignment plates 66 at both sides of the sheet width direction W, the sheet bundle SS is aligned in the sheet width direction W. The left and right horizontal alignment motors continue rotation while including temporary stop. The order of the horizontal alignment operations is as follows. First, the sheet bundle SS is aligned to a middle position of the sheet width direction W with a slight gap therebetween. Afterwards, the horizontal alignment of the sheet bundle SS is completed without the gap to move the sheet bundle SS to a sorting position. The driving timing of the left and right horizontal alignment motors is shifted from each other. The horizontal alignment process by the driving of the horizontal alignment plate 66 may be executed a timing at which the horizontal alignment process is simultaneously executed even after the vertical alignment process by the driving of the bundle claw 67 is started.

According to the post-processing apparatus 3 and the sheet processing method of the present embodiment, in a case in which the final sheet S2 of the sheet bundle SS is placed on the first tray (processing tray 61) and the first sheet S1 is placed on the receiving section (rear end stopper 65), the first sheet S1 placed on the receiving section is extruded by the convex part (bundle claw 67). While the first sheet S1 extruded by the convex part is conveyed to the second tray (the movable tray 23b), the conveyance section 68 is controlled in such a manner that one side of the final sheet S2 at the upstream side of the sheet conveyance direction is conveyed by being extruded by the convex part. Thus, the edge of the second sheet S2 at the upstream side of the sheet conveyance direction D2 abuts against the convex part even without abutting against the receiving section while the convex part extrudes the first sheet S1. The edges of the sheet bundle SS composed of the first sheet S1 and the second sheet S2 at the upstream side of the sheet conveyance direction D2 abut against the convex part, and in this way, the vertical alignment is executed to align the first sheet S1 and the second sheet S2 in the sheet conveyance direction D2. Thus, the vertical alignment process for backward feeding the second sheet S2 that becomes the final sheet of the sheet bundle SS to the upstream side of the sheet conveyance direction D2 to enable the second sheet S2 to abut against the receiving section is omitted or reduced, and it is possible to vertically align the first sheet S1 and the second sheet S2. Thus, it is possible to reduce the time of the alignment processing of the sheet bundle SS.

According to the post-processing apparatus 3 of the present embodiment, at the time the convex part (the bundle claw 67) extrudes the first sheet S1, the movement restriction member (rotating body 34) for restricting the movement of the second sheet S2 to the downstream side of the sheet conveyance direction D2 is provided.

According to the constitution, at the time the convex part extrudes the first sheet S1, as the movement of the second sheet S2 to the downstream side of the sheet conveyance direction D2 is restricted, the movement of the second sheet S2 to the downstream side of the sheet conveyance direction D2 due to the friction with the first sheet S1 is suppressed. Thus, while the convex part extrudes the first sheet S1, it is possible to enable the convex part to definitely abut against the second sheet S2 to execute the vertical alignment.

According to the post-processing apparatus 3 of the present embodiment, the rotating body 34 is driven in a state of contacting with the sheet S at the uppermost position on the processing tray 61 to backward feed the sheet S at the uppermost position to the upstream side of the sheet conveyance direction D2, and The movement restriction member uses the rotating body 34.

According to the constitution, the rotating body 34 combines a member for backward feeding the sheet S at the uppermost position arranged on the processing tray 61 at last and a restriction member for restricting the movement of the second sheet S2 to the downstream side to the sheet conveyance direction D2. Thus, the backward feeding of the sheet S at the uppermost position and the movement restriction of the second sheet S2 can be realized with a simple component.

According to the post-processing apparatus 3 of the present embodiment, the controller starts to extrude the first sheet S1 by the convex part (bundle claw 67) in a state of stopping the movement of the second sheet S2 by the rotating body 34.

According to the constitution, the first sheet S1 and the second sheet S2 can be vertically aligned after the time required for the backward feeding of the second sheet S2 is definitely shortened.

According to the post-processing apparatus 3 of the present embodiment, the controller backward feeds the second sheet S2 with the rotating body 34 and starts to extrude the first sheet S1 with the convex part in a state in which the second sheet S2 is moved away from the receiving section (rear end stopper 65) to the downstream side of the sheet conveyance direction D2.

According to the constitution, without changing the operation pattern of the rotating body 34, it is possible to enable the convex part which is extruding the first sheet S1 to abut against the second sheet S2 to execute the vertical alignment.

According to the post-processing apparatus 3 of the present embodiment, the standby tray 41 for enabling the sheet S conveyed to the post-processing apparatus 3 to stand by is arranged above the processing tray 61, and the standby tray 41 is an opening and closing type capable of dropping the standby sheet S to the processing tray 61.

According to the constitution, even when the preceding sheet bundle SS is processed at the processing tray 61, the conveyance of the sheet S is continued without stopping. After the preceding sheet bundle SS moves from the processing tray 61, the standby tray 41 is opened to drop the standby sheet S to the processing tray 61. If the standby of the sheet S is not necessary, the standby tray 41 keeps open and the sheet S can be directly conveyed to the processing tray 61.

According to the post-processing apparatus 3 of the present embodiment, the sheet drop member (assist guide 43) for extruding the sheet S at the time the sheet S standing by on the standby tray 41 is dropped to the processing tray 61 is provided, and the controller controls at least one of the rotating body 34 and the conveyance section 68 based on the operation timing of the sheet drop member while controlling the sheet drop member.

According to the constitution, based on the timing at which the sheet S is dropped to the processing tray 61, it is possible to promptly feed backward the first sheet S1 to execute the vertical alignment. In accordance with the timing at which the final sheet S2 is dropped, the extrusion of the first sheet S1 is promptly started and the second sheet S2 can be aligned.

According to the post-processing apparatus 3 of the present embodiment, the exit sensor 33c which detects the sheet S of the sheet discharge section 23 to the post-processing apparatus 3 is provided, and the controller controls at least one of the rotating body 34 and the conveyance section 68 based on the detection information of the sheet S by the sensor 33c.

According to the constitution, based on the detection information of the sheet S in a sheet discharge section 23, it is possible to promptly feed backward the first alignment S1 to execute the vertical alignment. Based on the detection information of the final sheet S2, it is possible to promptly start extruding the first sheet S1 to align the second sheet S2.

According to the post-processing apparatus 3 of the present embodiment, the horizontal alignment plate 66 for aligning the first sheet S1 and the second sheet S2 arranged on the processing tray 61 in the sheet width direction W crossing the sheet conveyance direction D2 is provided.

According to the constitution, the horizontal alignment of the first sheet S1 and the second sheet S2 can be executed in accordance with the vertical alignment of the first sheet S1 and the second sheet S2 by the convex part and the time required for the alignment processing of the sheet bundle SS can be shortened.

Although the configuration according to one embodiment is described above, the configuration of the sheet processing apparatus is not limited to the above example. For example, the sheet processing apparatus may be the image forming apparatus having an in-body finisher inside a casing thereof.

In the above embodiment, the backward feeding of the sheet S is executed by driving of the rotating body 34. However, the backward feeding of the sheet S is not limited to being executed by the driving of the rotating body 34. For example, a slope of the processing tray may be used to backward feed the sheet S by its own weight.

In the above embodiment, the movement of the second sheet S2 is restricted by using the rotating body 34. However, the movement restriction of the second sheet S2 is not limited to using the rotating body 34. For example, a movement restriction member different from the rotating body 34 may be provided.

According to at least one embodiment described above, the post-processing apparatus 3 comprises the first tray (processing tray 61), the second tray (movable tray 23b), the rotating body 34, the receiving section (rear end stopper 65), the conveyance section 68 and the post-processing controller 24. The movable tray 23b is arranged at the downstream side of the sheet conveyance direction with respect to the processing tray 61. The rotating body 34 conveys the sheet S on the processing tray 61. The rear end stopper 65 is arranged at the upstream side of the sheet conveyance direction with respect to the processing tray 61 and receives the sheet S conveyed by the rotating body 34. The conveyance section 68 extrudes one side of the sheet S placed on the processing tray 61 at the upstream side of the sheet conveyance direction by the convex part (bundle claw 67) to convey the sheet S to the movable tray 23b. In the case where the final sheet S2 of the sheet bundle SS is placed on the processing tray 61 and the sheet S is placed in the rear end stopper 65, the sheet S placed in the rear end stopper 65 is extruded with the bundle claw 67. The post-processing controller 24 controls the conveyance section 68 to convey of the final sheet S2 by extruding one side of the final sheet S2 at the upstream side of the sheet conveyance direction with the bundle claw 67 while the sheet S extruded at the bundle claw 67 is conveyed to the movable tray 23b.

Thus, the time required for the alignment processing of the sheet bundle SS can be shortened.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. A sheet processing apparatus, comprising:
a first tray;
a second tray arranged at a downstream side of a sheet conveyance direction with respect to the first tray;
a rotating body configured to convey a sheet on the first tray to the upstream side of the sheet conveyance direction;
a receiving section, arranged at an upstream side of the sheet conveyance direction with respect to the first tray, configured to receive the sheet conveyed by the rotating body;
a conveyance section configured to discharge one side of the sheet bundle placed on the receiving section and the final sheet placed on the sheet bundle at the upstream side of the sheet conveyance direction with a convex part to convey the sheet bundle and the final sheet to the second tray at a downstream side of the sheet conveyance direction; and
a controller configured to
start discharging the sheet bundle with the convex part when the final sheet is moved away from the receiving section while conveying the final sheet to the receiving section with the rotating body,
stop conveying the final sheet with the rotating body,
and control the conveyance section to convey the sheet by discharging one side of the final sheet at the upstream side of the sheet conveyance direction with the convex part after the sheet bundle is conveyed to the second tray.

2. The sheet processing apparatus according to claim 1, further comprising:
a movement restriction member configured to restrict movement of the final sheet to the downstream side of the sheet conveyance direction at the time the convex part discharges the sheet bundle.

3. The sheet processing apparatus according to claim 2, wherein
the rotating body is driven in a state of contacting with the sheet bundle at the uppermost position on the first tray to backward feed the sheet bundle at the uppermost position to the upstream side of the sheet conveyance direction, and
the movement restriction member is operated by the rotating body.

4-5. (canceled)

6. The sheet processing apparatus according to claim 1, further comprising:
a standby tray arranged above the first tray and configured to enable the sheet bundle conveyed to the sheet processing apparatus to stand by, wherein
the standby tray is an opening and closing type configured to drop the standby sheet bundle to the first tray.

7. The sheet processing apparatus according to claim 6, further comprising:
a sheet drop member configured to discharge the sheet bundle at the time of dropping the sheet bundle standing by on the standby tray to the first tray, wherein
the controller controls at least one of the rotating body and the conveyance section based on operation timing of the sheet drop member while controlling the sheet drop member.

8. The sheet processing apparatus according to claim 1, further comprising:
a sensor configured to detect the sheet bundle in a sheet conveyance path to the sheet processing apparatus, wherein
the controller controls at least one of the rotating body and the conveyance section based on detection information of the sheet bundle by the sensor.

9. The sheet processing apparatus according to claim 1, further comprising:
an alignment member for aligning the sheet bundle and the final sheet placed on the first tray in a sheet width direction crossing the sheet conveyance direction.

10. An image forming apparatus comprising an image forming section and the sheet processing apparatus according to claim 1.

11. A sheet processing method, comprising:
discharging one side of a sheet bundle placed on a receiving section and a final sheet placed on the sheet bundle at an upstream side of a sheet conveyance direction with a convex part to convey the sheet bundle and the final sheet to a second tray at a downstream side of the sheet conveyance direction; and
discharging the sheet bundle placed on a receiving section arranged at the upstream side of the sheet conveyance direction with respect to the first tray with the convex part when a final sheet of a sheet bundle is placed on the first tray and the sheet is placed on the receiving section, and
controlling the conveyance of the sheet by discharging the sheet bundle with the convex part when the final sheet is moved away from the receiving section while conveying the final sheet to the receiving section with the rotating body and stop conveying the final sheet with the rotating body and discharge one side of the final sheet at the upstream side of the sheet conveyance direction with the convex part after the sheet is conveyed to the second tray.

12. The sheet processing method according to claim 11, further comprising:
restricting movement of the final sheet to the downstream side of the sheet conveyance direction at the time the convex part discharges the sheet bundle.

13. The sheet processing method according to claim 12, further comprising:
driving a rotating body when contacting with the sheet bundle at an uppermost position on the first tray to backward feed the sheet bundle at the uppermost position to the upstream side of the sheet conveyance direction, and
using the rotating body for the restricting the movement of the final sheet.

14-15. (canceled)

16. The sheet processing method according to claim 11, further comprising:
holding the sheet bundle conveyed to standby; and
dropping the standby sheet bundle to the first tray.

17. The sheet processing method according to claim 16, further comprising:
discharging the sheet bundle at the time of dropping the sheet bundle standing by to the first tray; and
controlling at least one of the rotating body and the conveyance based on operation timing of the sheet dropping while controlling the sheet dropping.

18. The sheet processing method according to claim 11, further comprising:
detecting the sheet bundle in a sheet conveyance path to a sheet processing apparatus; and
controlling at least one of a rotating body and the conveyance based on detection information of the sheet bundle.

19. The sheet processing method according to claim 11, further comprising:
aligning the sheet bundle and the final sheet placed on the first tray in a sheet width direction crossing the sheet conveyance direction.

20. The sheet processing method according to claim 11, further comprising:
before discharging one side of the sheet bundle placed on the first tray, forming an image on the sheet bundle; and
conveying the sheet bundle to the first tray.
